(19) United States
(12) Patent Application Publication
(10) Pub. No.: US 2012/0073994 A1
(43) Pub. Date: Mar. 29, 2012

(54) METHOD AND DEVICE FOR ENSURING MINT-DIRECT PACKAGING IN TAMPER-EVIDENT PACKAGING

(75) Inventor: Michael R. Haynes, Oklahoma City, OK (US)

(73) Assignee: AMERICAN PRECIOUS METALS EXCHANGE, INC., Oklahoma City, OK (US)

(21) Appl. No.: 13/245,573

(22) Filed: Sep. 26, 2011

Related U.S. Application Data
(60) Provisional application No. 61/386,370, filed on Sep. 24, 2010.

(51) Int. Cl. A45C 1/00; B23P 11/00

(52) U.S. Cl. 206/82; 29/505

(57) ABSTRACT

A coin storage device and a method for using the coin storage device includes a coin tube with a diameter, a cylindrical body, a cap, and a casing with a diameter slightly larger than the diameter of the coin tube. The casing is shaped so as to conform to the coin tube, which is positioned within the casing. The coin tube may include an embossed label and can be configured to accommodate at least 20 coins. The casing may consist of a shrink wrap film, and can be manufactured from a variety of substances, including polyolefin and polyvinyl.

### RELATED APPLICATIONS

The present application claims the benefit of U.S. Patent Application No. 61/386,370, entitled Method and Device for Ensuring Mint-Direct Packaging in Tamper-Evident Packaging, filed Sep. 24, 2010, the disclosures of which are incorporated herein.

### FIELD OF INVENTION

The present invention relates generally to the field of precious coins and more particularly to a method and device for ensuring the authenticity and genuine quality of coins produced by a mint.

### BACKGROUND OF THE INVENTION

Coin collectors and investors frequently purchase coins produced by mints located around the world. The mints typically ship coins to distributors or retailers in sealed, tamper-evident boxes that usually contain between 20-50 coin tubes. Each coin tube typically contains about 20-25 coins. Coin tubes often comprise an opaque plastic cylinder with an open end. The coin tube includes a removable cap that provides access to the inside of the tube. Notably, the individual coin tubes do not include a tamper-evident device.

Upon arrival, the retailer opens the sealed box to gain access to the coin tubes. In the past, the retailer has either shipped the entire coin tube to customers or removed the coins from the coin tube for individual sale. In either case, it has been impossible for the customer to easily verify that the coins were not disturbed or altered by the retailer. It is to these and other deficiencies in the prior art that the present invention is directed.

### SUMMARY OF THE INVENTION

In a preferred embodiment, the present invention includes a coin storage device and a method for using the coin storage device. The coin storage device preferably includes a coin tube with a diameter, a cylindrical body, a cap, and a casing with a diameter slightly larger than the diameter of the coin tube. The casing is shaped so as to conform to the coin tube, which is positioned within the casing. The coin tube may include an embossed label and can be configured to accommodate at least 20 coins. The casing may consist of a shrink wrap film, and can be manufactured from a variety of substances, including polyolefin and polyvinyl.

### BRIEF DESCRIPTION OF DRAWINGS

FIG. 1 presents a side view of a coin tube.

FIG. 2 presents a side view of the coin tube of FIG. 1 encased within the sealing device of the present invention.

### DETAILED DESCRIPTION OF PREFERRED EMBODIMENTS

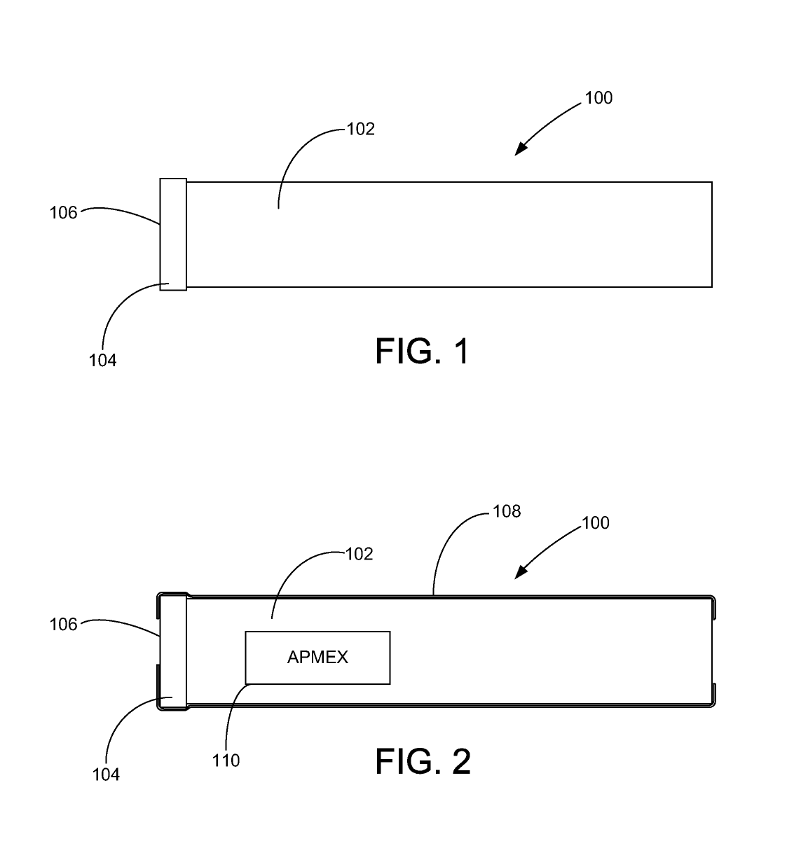

Referring to FIG. 1, shown therein is a coin tube 100. The coin tube 100 includes a cylindrical body 102 with a closure cap 104. The body 102 is manufactured from a suitable plastic and sized to accommodate about 20 coins. The coin tube 100 also typically includes an embossed label 106 on the cap that identifies the mint that manufactured the coins. The cap 104 may be color-coded to provide additional information about the coins contained within the coin tube 100. The cap 104 may be removed from the body 102 to provide access to the coins contained therein.

Turning to FIG. 2, shown therein is a side view of the coin tube 100 encased within a casing 108 constructed in accordance with a presently preferred embodiment. In a presently preferred embodiment, the casing 108 constitutes a shrink wrap film. In a particularly preferred embodiment, the shrink wrap casing 108 is an open-ended cylinder with an inside diameter slightly larger than the outside diameter of the coin tube 100. In an alternate preferred embodiment, the shrink wrap casing 108 is a cylinder with one end closed and one end opened. Suitable shrink wrap materials include polyolefin shrink wrap and polyvinyl chloride (PVC) shrink wrap. Polyolefin shrink wrap film is a cost-effective film that exhibits strong, shape conforming properties. Polyolefin shrink film is clear, elastic, and has a smooth texture. In contrast, PVC shrink wrap film exhibits a coarser texture. In a particularly preferred embodiment, the casing 108 includes a proprietor's label 110 placed beneath the shrink wrap film that includes information regarding the retailer and a statement of authenticity.

In a presently preferred method, the casing 108 is applied to the coin tube 100 according to the following steps. In a first step, the coin tube 100 is removed by the retailer from the sealed box shipped from the mint. The proprietor's label is placed on the outside of the coin tube 100. The coin tube 100 is then immediately placed into the casing 108 without removing the cap 104 or otherwise tampering with the coin tube 100. Once the casing 108 is positioned over the coin tube 100, heat is applied to the casing 108 to cause the casing to contract and conform to the coin tube 100. Heat can be applied through industry-accepted means, including, for example, heat guns and oven systems. Once contracted by heat, the casing 108 provides a tamper-evident assurance that the coin tube 100 has not been opened since the original packaging at the manufacturing mint. In this way, consumers can be assured of the authenticity and original nature of the coins contained within the coin tube 100. The casing 108 is also helpful in the event the purchaser later elects to liquidate the coin tube 100. Because the casing 108 contains the proprietor's label 110, subsequent purchasers can be assured that the original representation of authenticity from the retailer is valid. The ability to assure the consumer that the coins have not been removed from the original mint packaging provides additional value and prestige to the coin purchase transaction. The

[symbol]

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest them to those skilled in the art and which are encompassed within the spirit of the invention disclosed herein and in the associated drawings. For example, it will be appreciated that the instant invention may find utility in preserving the authenticity of other products delivered from a mint. In an alternate preferred embodiment, the boxes which are used to ship the coin tubes from the mint can be sealed using a casing 108 configured to encase the entire unopened coin box.

It is claimed:

1. A coin storage device, the device comprising:
a coin tube having a diameter, the coin tube comprising:
a cylindrical body;
a cap; and
a casing having a diameter slightly larger than the diameter of the coin tube, wherein the coin tube is positioned within the casing, and the casing is conformed to the coin tube.

2. The coin storage device of claim 1, wherein the coin tube also comprises an embossed label.

3. The coin storage device of claim 2, wherein the coin tube is configured to accommodate at least 20 coins.

4. The coin storage device of claim 2, wherein the casing is a shrink wrap film.

5. The coin storage device of claim 4, wherein the casing is polyolefin.

6. The coin storage device of claim 4, wherein the casing is polyvinyl.

7. The coin storage device of claim 4, wherein the casing further comprises a proprietors label.

8. A method for creating a tamper evident coin storage device, the method comprising of the following steps:
removing a coin tube from a box;
placing a label on the outside of the coin tube;
placing the coin tube into a casing; and
causing the casing to contract and conform to the coin tube by applying heat to the casing.

9. The method of claim 8, wherein the heat is applied through a heat gun.

10. The method of claim 8, wherein the heat is applied through an oven system.
